(19) United States
(12) Patent Application Publication
(10) Pub. No.: US 2010/0085180 A1
(43) Pub. Date: Apr. 8, 2010

(54) Deceleration Brake Light System

(76) Inventor: Monica JoElla Mathis, Washington, DC (US)

Correspondence Address: Monica Mathis, 900 Rittenhouse Street NW, Washinton, DC, 20011, US

(21) Appl. No.: 11/969,398

(22) Filed: Oct. 3, 2008

(51) Int. Cl. B60Q 1/44

(52) U.S. Cl. 340/467; 340/479

(57) ABSTRACT

The purpose of the invention is to improve and upgrade the existing automobile brake system. Currently, when a motorist pushes the foot brake in the car to decelerate a Light Emitting Diode (LED) indicator mounted on the trunk and in the rear windows of a vehicle lights up to indicate slowing down and stopping. In most vehicle LED systems, the distinction between a deceleration, hard braking, and a stop cannot be indicated or differentiated. The goal of the invention is to create a braking indication system that will demonstrate how fast a car is decelerating with LED arranged in a fashion to turn on proportional to the amount of pressure applied to the brake. Once pressure is applied, the brakes are applied and the brake light will let the vehicle behind know how quickly the vehicle is slowing down by showing an approximation using the LED display. Therefore if a driver is to lightly tap on his brakes, the brake indicator will light a small amount of LED to symbolize slowing down but not stopping. Adversely, if a driver “slams on the brakes,” an additional complete row of brake lights will illuminate to indicate you need to brake hard or consider an evasive action to avoid collision.

### BACKGROUND INFORMATION

The original brake light system was installed for the convenience of seeing the rear on the car in less than desirable conditions. The brake light is a component of the braking system that notifies the driver to the rear that a car is slowing or stopping. This system begins with the brake pedal which is user controlled. When the brake pedal is depressed the mechanical brake system slows or stops the car using friction. On the depression of the brakes the red lights located on the rear of the car turns on.

### History—Traditional Braking Light Systems

Brake lights were 1^{st} introduced in the early 1900's, with the introduction of the license plate light. Next, there was the addition of directional signal lights and brake lights for the rear of the vehicle. Modern vehicle signal lights have numerous turn, brake, parking, reverse, fog, and puddle lights.

### How Deceleration Brake Lights System Works

To simulate the deceleration of a car during the braking process, I have created a pedal made of wood, hinges and springs. When the car operator pushes the brake pedal, a mechanical signal is created; that signal is then converted to an electrical signal, and run through a system of signal amplifiers and analog to digital (A/D) conversion, then on to the LED lights.

The brake pedal is connected to a potentiometer. A potentiometer is an apparatus used to measure the potential (or voltage) in a circuit by introducing a resistance to a known voltage using a mechanical side or rotary adjustment. Using the concept of the Wheatstone bridge; when a force acts upon the circuit, the resistance value changes, and a voltage appears between two terminals. This is similar to the concept of common mode voltage.

The potentiometer is connected through signal conditioner circuits. An amplifier is used to magnify the terminal of a signal to usable range and an analog to digital converter to provide systematically discrete value of the input. This circuit is necessary to analyze and prepare the signal for use in controlling the LED circuit output. The amplifier is processed through a standard gain circuit using an operational amplifier and resistor network to control the gain amount. Typically, the output voltage from the potentiometer registers in the order of a few milli-volts, at maximum. The gain circuit will bring the potential of the system to voltages in the range of 1V to 3V. In the prototype, this signal will then be entered into LabView through the use of a Digital Acquisition (DAQ) system, which consists of an A/D converter and a multiplexer. In LabView, a signal goes through conditioning where it is then output back through the GPIB system and sent to the Light Emitting Diodes; LEDs brake lights.

The Deceleration Brake Indicator System is configured so the LEDs turn on in a specified order proportional to the pressure applied to the brakes. The more pressure applied to the brakes, the more lights turn on in order from the outermost LEDs to the middle of the LED display. When the analog signal is converted to digital, it registers as discrete values that determine the differing voltages. These discrete signals determine how many LEDS light turn on in the braking system.

### Thesis

### Deceleration LED System

The Deceleration Brake Indication System differs from traditional brake lights use in that the illuminates turn on proportional to the pressure applied to the brakes. Standard braking systems use LED that all turn on when the brakes are touched. They show no indication of the rate of deceleration, nor do they differentiate between a deceleration and hard braking to a stop. My system is designed so when the brakes are pressed, the LED illuminates in order from the outermost at both ends of the linear fixture to the middle of the fixture where they touch. The manner and number in which the LEDs turn on is controlled by how much pressure is initially applied by the user.

### Prototype Design

### Components

The pedal was created using a simple design. Two wooden slats are connected together with a simple door hinge. For resistance, a spring was added to the underside of the top wooden slat. A small spring extended is also extended from the analog meter to the pedal to reset the position of the meter when the brake is not being used. The slender rod is connected from the pedal to push the meter when the brakes are applied. This is the primary source used to create the analog signal.

### Rheostat

Connected to the pedal by a metal rod is a Rheostat. A rheostat is a linear or fader style potentiometer. A potentiometer is a mechanical device that changes mechanical movement to a proportional voltage. The rheostat is a metal bar of a known resistance, with a moving slider across the top. Our rheostat has a value range of 0 to 490K. The rod from the pedal pushes a plastic slider of the potentiometer back and forward along a path to vary the value of the resistance. This in turn changes the value of the voltage. Hence, the output voltage is proportional to the pressure applied to the brakes. A 3.5V potential is connected to the rheostat. The rheostat is interchangeable with a pressure sensor. My prototype was constructed with a rheostat for simplicity and cost effectiveness.

### Signal Conditioning Simulation in LabView

In the prototype, LabView has been used for the purpose of circuit conditioning. LabView is used to bring the value of the voltage signal to levels between 1V to the voltage of 3V. Through the use of the multiplier function we can increase the gain of the circuit. We then send the signal through an A/D converter. This will the signals into separate it into a range associated with their discrete value. The values are associated with group sections of LEDs. This enables the circuit to turn on in sections. So, if the user steps on the brakes lightly, the LEDs in the 1V section will turn on. For medium braking, all the lights in the 2V section turn on and also the light of the 1V sections. For hard braking and sudden stops, all the lights in the row turn on. LabView will assign discrete values and send the values through an interface system.

The Data Acquisition (DAQ) system is used to measure and generate a physical signal. When using potentiometer to create an electrical signal, often times the signal is not large enough for practical analog to digital conversion. Therefore, the signal needs to be amplified first before the conversion can be done. In LabView, I used a process called transducer excitation to condition the signal for A/D conversion processing. Amplification is done to maximize the available voltage range to increase the accuracy of the digitized signal. We are using a non-referenced single ended system, because the signal we are taking is a floating signal (coming in from a transducer).

When conditioning a signal while using the DAQ system, there are 4 parameters to consider: A/D conversion resolutions, device range, signal input range, and sampling rate. A/D conversion resolution is determined by the number of bits used to represent an analog system. This was accomplished by taking a ruler to measure the length of the rheostat, using a ruler marked in millimeters. The device range is the minimum and the maximum analog system level that the A/D converter can handle. For this system the data minimum and maximum data range will be 1V to 3V, respectively. The signal input range is the minimum and maximum values of the input signal you are measuring. Lastly, the sampling rate is the rate at which the DAQ device samples an incoming analog signal, which depends on how often a conversion is actually taking place. The resolution, range of the DAQ system, and the signal input range determine the rate of change in the input voltage which is given by:

V_{cw}=range/2resolutions,

Where the resolution is given in bits.

In LabView, I created a block diagram to symbolize what the conditioning system will have to go through using DAQ assistant. DAQ Assistant is a graphical interface that can be used to configure measurement tasks and channels. Within DAQ Assistant we calculate the inputs for our system including: the analog input, voltage, set-up input channels, and run tests. From this point, we can change the all the options for the system in order to get the appropriate signal. We also created a display window to see the signal created after all the conditioning has taken place. The components of the block diagram consist of all the conditional tools used to transform our signal, which represents the signal collected by the GPIB component for interface between the internal and external equipment. There is also a digital output for the system to discretely control the LED display.

### Analog to Digital Conversion in LabView

The signal we collected in from the rheostat is naturally analog in nature so we use analog to digital conversion in LabView to complete the conditioning. Using the Analog to Digital VI, we converted the data to digital by sampling the measurement from the rheostat, the range on the signal, and a gain also applied in LabView. The digital waveform components are then extracted from the sampled data values. To graph the signal in a digital waveform graph, you must convert the raw data you acquire into the digital data type or the digital waveform data type.

### LED Display

The output of the conditioned signal will be sent to the Light Emitting Diode (LED) modules. LEDs are configured of semiconducting materials that release electrical energy in the form of light when a signal is applied. LEDs are standard and widely used due to their generally small sizes, and their ability to last longer than other lighting technologies.

The LED prototype circuit consists of LEDs arranged in 3 levels with 15 LED lights in each level. The LEDs are grouped together into 3 groups. The group 1, 1V LEDs are on both ends of the circuit. Group 2, 2V LEDs illuminates for intermediate voltages. The highest voltage, 3V LEDs are located in the center of the LED display. This arrangement visually completes a straight line. Each section corresponds to a voltage level and the voltage sent to each group is controlled by the digital signal at the output of LabView. Depending on the pressure applied to the brake pedal the corresponding voltage and lower voltages turn on.

Overall the design overall was a success. There were some changes made to the design different from the original proposal:
The design of the light changes from pulsing to a voltage varied stream.
A power supply outside was added at the rheostat configuration.
The potentiometer changed from a signal turn rotary style to a linear faded due to friction and control issues.
The wiring configuration was changed to take advantage of grouping to cut down on output channels.
A resistance of 1M was coupled with the rheostat to prevent overload of the LED

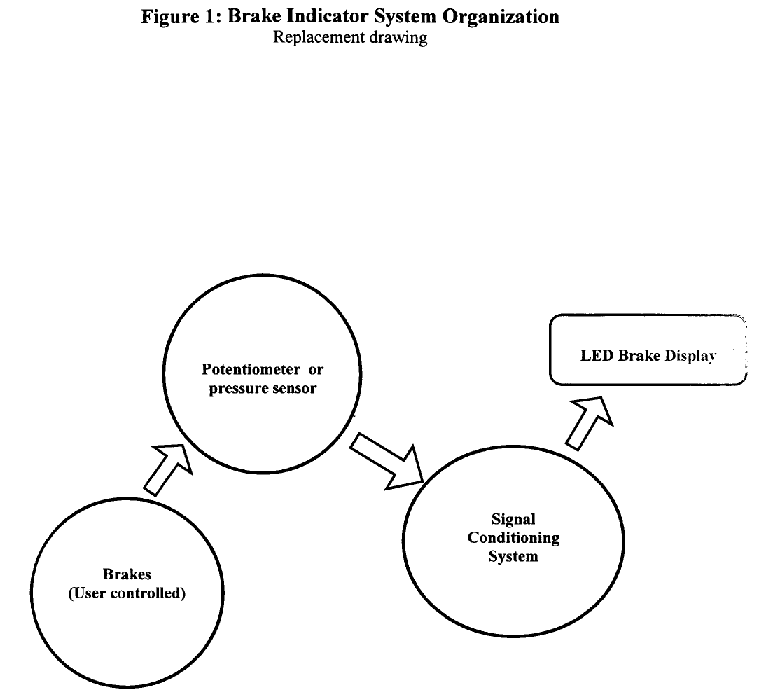

FIG. 1: Brake Indicator System Organization

Replacement Drawing

This is an organizational chart of the entire Deceleration Brake Indication system. Starting with the user controlled brake pedal. This component of the system determines the type of braking pressure category base on the pressure the motorist applies to the brakes. From the braking pedal the system goes to the potentiometer and pressure sensor. This is also where the mechanical movement is converted into electrical potential. The electrical signal created in the potentiometer is then processed through a conditioning circuit. The conditioning circuits are responsible for multiplying the signal to a usable size and changing a naturally continuous signal into digital and discrete values. Our signal conditioning is performed in LabView for simulation purposes. The output for the signal is then sent to the Deceleration LED indicators located on the back of the vehicles.

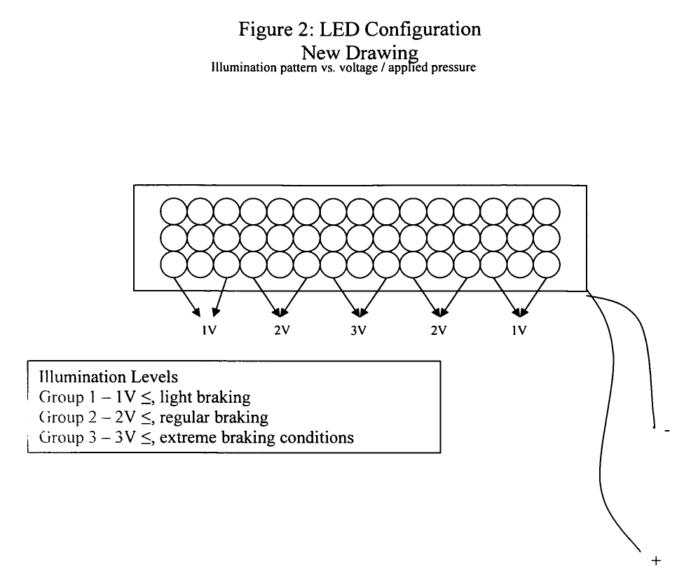

FIG. 2: LED Configuration New Drawing

The LEDs are configured to turn on proportional to the pressure applied to the brake pedal. The Indicator panel is wired such that the LED groups turn on when their discrete value, determined by the conditioning system, appeared at the output the conditioning circuits.

The LED prototype circuit consists of LEDs arranged in 3 levels with 15 LED lights in each level. The LEDs are grouped together into 3 groups. The group 1, 1V LEDs are on both ends of the circuit. Group 2, 2V LEDs illuminates for intermediate voltages. The highest voltage, 3V LEDs are located in the center of the LED display. This arrangement visually completes a straight line.

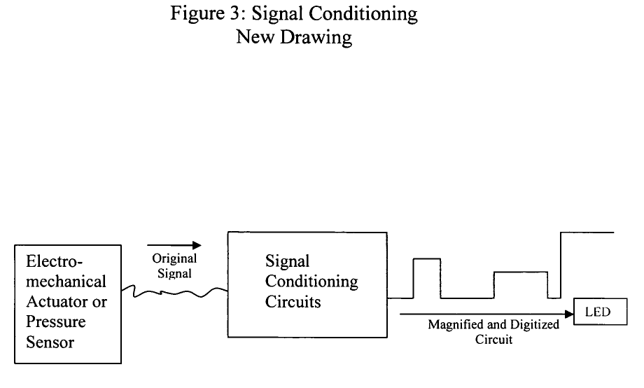

FIG. 3: Signal Conditioning New Drawing

From the pressure sensor/potentiometer, the signal produced is typically within the scale of millivolts. This signal is sent to the conditioning circuits, which are in charge of scaling the signal to appropriate levels, and changing the signal from analog to digital. The new magnified, digitized signal is then sent to the LED indicators and discrete values within the 1V to 3V ranges.

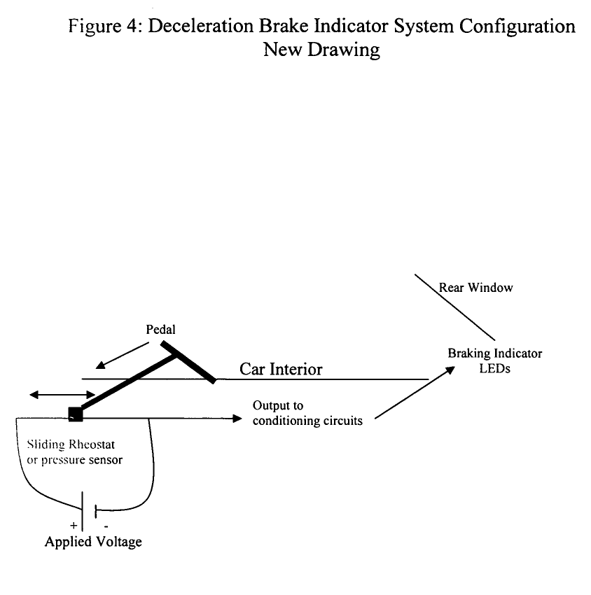

FIG. 4: Deceleration Brake Indicator System Configuration New Drawing

With respect to the vehicle, the Deceleration Brake Indication System has 4 system components starting with the brake pedal, potentiometer/pressure sensor, conditioning system and LED indicators. To simulate the deceleration of a car during the braking process, I have created a pedal made of wood, hinges and springs. When the car operator pushes the brake pedal, a mechanical signal is created; that signal is then converted to an electrical signal, and run through a system of signal amplifiers and analog to digital (A/D) conversion, then on to the LED lights.

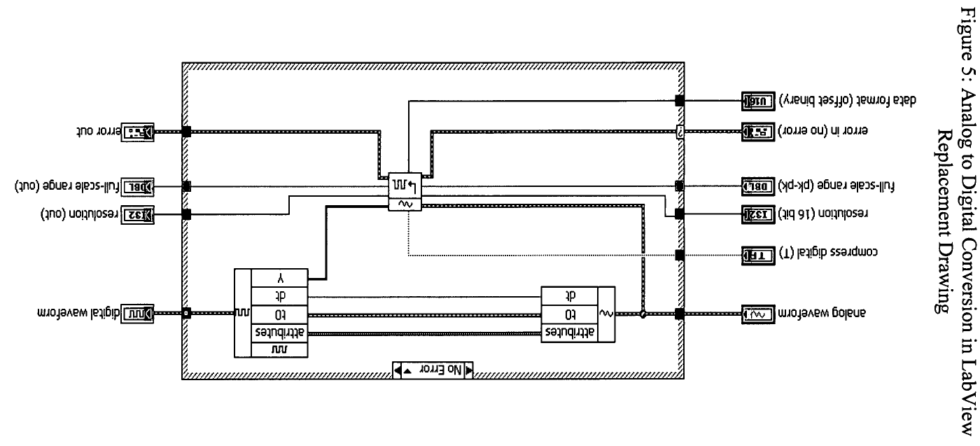

FIG. 5: Analog to Digital Conversion in LabView Replacement Drawing

In LabView, I created a block diagram to symbolize what the conditioning system will have to go through using DAQ assistant. In DAQ Assistant, we calculate the inputs for our system including: the analog input, voltage, set-up input channels, and run tests. The components of the block diagram consist of all the conditional tools used to transform our signal, which represents the signal collected by the GPIB component for interface between the internal and external equipment. There is also a digital output for the system to discretely control the LED display. Using the Analog to Digital VI, we converted the data to digital by sampling the measurement from the rheostat, the range on the signal, and a gain also applied in LabView.

### BIBLIOGRAPHY

Bishop, Robert H. “Chapter 9—Data Acquisition (DAQ).” Bishop. LabView 8—Student Edition. Upper Saddle River, N.J.: Pearson Prentice Hall, 2007.384-451.
Hambley, Allan R. Electronics—Second Edition. Edited by Marcia Horton. Upper Saddle River, N.J.: Tom Robbins—Prentice Hall Incorporated, 2000.
Luther, Erik. DSP Laboratory: Analog to Digital and Digital to Analog Conversion. The Connexion Project, Creative Commons Organization, 2005.
Merriam-Webster Incorporated. The Merriam-Webster Dictionary. Springfield, Mass.: Merriam-Webster Incorporated, 1997.
Reidel, James W Nilsson and Susan A. Electric Circuits—Seventh Edition. Upper Saddle River, N.J.: Pearson Prentice Hall, 2005.
Wikipedia. Wikipedia, Free Encyclopedia. October 2006. 17 Nov. 2006<www.wikipedia.com>.

What I claim as my invention is the following:

1. A braking indication system that illuminates proportional to the rate of deceleration

2. Brake lights that turn on in sequence controlled by a digitized voltage determined by how hard the brakes in a vehicle are pressed.

3. A braking indication system which visually shows how fast a car is braking (decelerating)

4. A brake indication system that is controlled that determines the LED indication display proportional to pressure applied to the user controlled brake pedal.

5. A pressure-control brake indication system that is placed through a conditioning system, whose output is a discrete digital electrical signal, which in turn controls the order and amount of indicators that light.

6. A braking indication system that differentiates between slowing, hard braking, and stopping.

7. A brake-pressure-controlled mechanical signal that is then converted to an electrical signal, and run through a system of signal amplifiers and analog to digital (A/D) conversion, then on to the LED lights.

8. A brake indication system designed so when the brakes are pressed, the LED illuminates in order from the outermost at both ends of the linear fixture to the middle of the fixture where the LED touch, which turns on proportional to pressure applied to the brakes.
